(19) United States
(12) Patent Application Publication
(10) Pub. No.: US 2014/0272906 A1
(43) Pub. Date: Sep. 18, 2014

(54) MASTERY-BASED ONLINE LEARNING SYSTEM

(71) Applicants: Mark C. Flannery, Plymouth, MN (US); Ahmad K. Asdi, Maple Grove, MN (US); Shauna S. Becker, Minneapolis, MN (US); Steve Anastasi, Lino Lakes, MN (US); Erik C. Jordan, Saint Paul, MN (US); Dack S. Ragus, Edina, MN (US); Adisack Nhouyvanisvong, Minnetonka, MN (US)

(72) Inventors: Mark C. Flannery, Plymouth, MN (US); Ahmad K. Asdi, Maple Grove, MN (US); Shauna S. Becker, Minneapolis, MN (US); Steve Anastasi, Lino Lakes, MN (US); Erik C. Jordan, Saint Paul, MN (US); Dack S. Ragus, Edina, MN (US); Adisack Nhouyvanisvong, Minnetonka, MN (US)

(21) Appl. No.: 13/838,373

(22) Filed: Mar. 15, 2013

(51) Int. Cl. G09B 7/06

(52) U.S. Cl. CPC G09B 7/06
USPC 434/362

(57) ABSTRACT

An online learning system includes a student engine, a courses engine and a reports engine. The student engine processes identification information for students registered in an online university. The courses engine includes a competencies engine, a challenges engine and a milestones engine. The competencies engine organizes online courses into topics of study. The challenges engine provides one or more series of open-ended questions on the topics of study. The milestones engine provides a series of multiple choice questions on the topics of study. The multiple choice questions are only accessible when a percentage of the open-ended questions in each of the series of open-ended questions are answered correctly. The reports engine provides data relating to student performance.

### BACKGROUND

In today's educational environment, students may learn in a variety of ways. A traditional approach for college is enrolling in an accredited college or university and taking classes at the college or university. In this approach, students attend classes at the college of university in a traditional classroom setting, where they are taught by instructors at the college or university and where they take exams at the college or university to verify mastery of subject matter in the classes.

With the advent of the Internet, online universities have provided an alternative to the traditional approach. Students may take classes over the Internet from their home or other locations. Exams are typically also given online. However, many online universities still use a traditional lecture/exam system, whereby students view lectures online, study material associated with the lectures, such as textbooks and lecture notes and then are tested at various times to verify mastery of the material being taught. Students may be required to learn class material at a time and pace dictated by the online university rather than at a time and pace that may be more suited to the student's mastery level of the material and personal life situation.

### SUMMARY

Embodiments of the disclosure are directed to a method implemented on an electronic computing device for learning in an online university. The method comprises: on the electronic computing device, rending a first user interface for the online university, the user interface permitting the selection of one or more online courses; receiving a selection of an online course; after the selection of the online course is received, rendering a second user interface showing a plurality of challenges and a milestone associated with a first topic of a plurality of topics included in the online course, each challenge corresponding to a plurality of first questions relating to the first topic, each first question being an open-ended question, each milestone corresponding to a plurality of second questions relating to the first topic, each second question being a multiple choice question; receiving answers to the first questions for each of the challenges; when a number of correct answers to the first questions of each challenge is greater than a first predetermined percentage, rendering a third user interface on the electronic computing device, the third user interface showing the plurality of second questions relating to the first topic, the third user interface prevented from being rendered until the correct answers to the first questions for each of the challenges is greater than the first predetermined percentage; receiving answers to the second questions; and receiving answers to the second questions; and when a number of correct answers of the plurality second questions is greater than a second predetermined percentage, designating that the milestone for the first topic has been passed.

In another aspect, a web server computer includes a processor and memory. The memory contains executable instructions, which when executed by the processor cause the processor to generate web page data and to communicate the web page data across a data communication network to end user computing devices, the web server being communicatively connected to a database, wherein the web page data generated by the processor defines at least a first web page for online learning, the first web page comprising a plurality of topics associated with an online course, each topic including a plurality of challenges and one milestone, each challenge comprising a first series of questions related to the online course, the milestone comprising a second series of questions related to the online course, wherein the milestone is not available to the student until a test score on each of challenges is above a first predetermined percentage.

In yet another aspect, an online learning system implemented at least in part on a server computer comprises: a processor; a memory; a student engine, the student engine processing identification information for a plurality of students that are registered in the online learning system; a courses engine, the courses engine providing access to one or more online courses that are available to the plurality of students, the courses engine comprising: a competencies engine, the competencies engine organizing each of the one or more online courses into topics of study; a challenges engine, the challenges engine providing one or more series of first questions to test a student's understanding of each of the topics of study, each of the one or more series of first questions being designated as a challenge, each of the one or more series of first questions being open ended, requiring a student to formulate an answer; and a milestones engine, the milestones engine providing a plurality of second questions to test the student's understanding of each of the topics of study, each of the second questions being multiple choice questions, the second questions being accessible to the student only after all challenges for a unit have been passed, the passing of a challenge comprising correctly answering at least half of the first questions for the challenge; and a reports engine that provides data relating to student performance.

The details of one or more techniques are set forth in the accompanying drawings and the description below. Other features, objects, and advantages of these techniques will be apparent from the description, drawings, and claims.

### BRIEF DESCRIPTION OF THE DRAWINGS

FIG. 1 shows an example system that supports a mastery-based online learning system.

FIG. 2 shows example engines of the web server computer of FIG. 1.

FIG. 3 shows example engines of the course engine of FIG. 2.

FIG. 4 shows an example home page user interface for a student.

FIG. 5 shows an example user interface for an example course.

FIG. 6 shows another example user interface for the course of FIG. 5.

FIG. 7 shows yet another example user interface for the course of FIG. 5.

FIG. 8 shows an example user interface for a video tutorial.

FIG. 9 shows an example user interface for a practice milestone exam.

FIG. 10 show an example user interface for a study guide.

FIG. 11 shows an example result screen for the oxygen saturation measurement.

FIG. 12 shows an example user interface for a student report.

FIG. 13 shows example physical components of the web server computer of FIG. 1.

FIG. 14 shows an alternate view of example components of the system shown in FIG. 1.

### DETAILED DESCRIPTION

The present disclosure is directed to a system and methods for mastery-based online learning. Students are directed to learn at their own pace and are not required to attend classes or view lectures of material that needs to be mastered. Instead, the students are presented with problems to solve and it is up to the student to learn the material required to solve the problems. The problems are typically based on real world situations, to make the problems relevant to the student. When the students demonstrate mastery of a topic, the students are permitted to advance to a next topic.

The system and methods are based on a concept that many students, especially older students having life experiences, may already know some or all of the material. Therefore, there isn't a need to force students to attend a class or view an online lecture that may be boring to them and that may not be useful. Instead, online tutorials are provided to help the student learn, and to help the student learn at their own pace. In this disclosure, the system and methods are directed to learning in an online university. However, the system and methods may also be used at other educational levels, for example at an elementary, middle school, high school or technical school level.

Using the system and methods, students choose one or more online courses for example college algebra or human biology. Each course is organized into a series of major topics, known as competencies. For each competency in a course, a student must pass a series of preliminary exams known as challenges and then pass a milestone for the competency. The challenges present the user with a series of open ended questions relating to the competency. If the student does not know how to answer a question, the student may view one or more video tutorials that are linked to the challenge. A student must correctly answer at least half of the questions for each challenge in order to advance to a milestone. Because the challenge questions are open ended, meaning that the student must formulate an answer, the student is given a predetermined number of attempts to correctly answer a challenge question. If the student does not correctly answer a challenge question within the predetermined number of attempts, the answer to the question is displayed to the student to enhance the student's learning.

After the student has passed all required challenges for a milestone (i.e. obtained over half the questions correct for each challenge), the student must pass the milestone. The milestone is a multiple question exam that is timed. The student must answer at least half the questions correct on the milestone in order to pass the milestone. However, the student must achieve a score of 70 percent across all challenges and the milestone in order to pass a competency. In other examples of the system and methods, different pass rates may be used for challenges, milestones and competencies.

One challenge presented to administrators of the system and methods is verifying identities of students taking the challenges and milestones to ensure academic integrity. Therefore, after a student passes all competencies for a course, the student is required to pass an ID verification milestone. The ID verification milestone is proctored online to ensure student authentication. In some examples, the ID verification milestone consists of 25 questions that are obtained from completed milestones within a course. Only questions that have been answered correctly by the student are used. The student must pass the ID verification milestone in order to successfully complete the online course. Typically, a student must correctly answer 70% of the questions on the ID verification milestone in order to pass the course. Other percentages may be used. In some embodiments, the student may receive college credit for completing the online course. However, in other embodiments, the student may pass the course and not receive college credit. For example, the student may receive a certificate of completion or other type of recognition.

Each student in the online university is typically assigned a learning coach to help the student advance through the course. The learning coach is typically available by online chat through a link on the online university website. The learning coach may help the student with understanding concepts related to subject matter in a course and may help the student plan when to take challenges and milestones within the course. The learning coach may also help the student plan next steps if the student were to fail a milestone. Other help may be provided by the learning coach.

FIG. 1 shows an example system 100 that may be used to support mastery-based online learning. The system 100 includes client computer 102, mobile electronic device 104, network 106, web server computer 108 and database 110. Client computer 102 may be a desktop computer or a laptop computer. Mobile electronic device 104 is typically a smart telephone. Network 106 is typically the Internet, a wireless telephone network or a combination of the two. Web server computer 108 hosts a website for an online university. Database 110 stores student and other data related to the online university. Students using client computer 102 or mobile electronic device 104 login over network 106 to the online university website hosted on web server computer 108. More than one client computer, mobile electronic device, web server computer and database may be used. In some examples, the web server computer may be part of a web server farm. In some examples, parts of the system may be located on multiple server computers, on multiple web server farms and on multiple databases. The web server computers, web server farms and multiple databases are accessible via network 106.

FIG. 2 shows example engines of web server computer 108. The web server computer 108 includes a student engine 202, a courses engine 204, and a reports engine 206. The student engine 203, courses engine 204 and reports engine 206 are abstractions for software engines that may be implemented on web server computer 108, on database 110 or on other server computers or databases accessible via network 106. Some of the functionality in each software engine may also be implemented in other software engines.

The example student engine 202 includes information for a plurality of students that are registered at the online university website. The information includes profile information for each student, including name, address, cell phone number, email address, interests, preferences, etc. Also included is information about course status for each student, including courses signed up for, progress information for each course, test scores, etc. Other information may be stored in the student engine 202.

The example courses engine 204 includes information for each course made available to students by the online university. The courses engine 204 includes the competencies that comprise each course. Also included are the challenges and milestones associated with each competency. The courses engine 204 also includes the ID verification milestone for each course and the tutorials that are associated with each course. The challenges, milestones and tutorials may be stored in database 110 and made available to web server computer 108. However, the challenges, milestones and tutorials may also be stored on any database or web server computer that is accessible by network 106.

The reports engine 206 provides a performance record of each active student at the online university. An active student is a student that is currently registered for at least one course. The reports engine compiles statistics for courses taken for each active student. The statistics may include correct answers, number of questions available and attempted answers to questions for each challenge in a course. Also included are a number of times a student has viewed tutorials in the course. The information may also include correct answers and number of questions available for each milestone in the course and for the ID verification milestone for the course. Other statistics may be possible.

FIG. 3 shows example engines of the courses engine 204. The courses engine 204 includes a competencies engine 302, a challenges engine 304, a milestones engine 306, a tutorials engine 308, and an ID verification milestone engine 310. The competencies engine 302, challenges engine 304, milestones engine 306, tutorials engine 308, and ID verification milestone engine 310 are abstractions for software engines that may be implemented on web server computer 108, on database 110 or on other server computers or databases accessible via network 106. Some of the functionality in each software engine may also be implemented in other software engines.

The example competencies engine 302 includes all the competencies that comprise a course. Competencies are major topics within a course. For example, for a college algebra course, competencies may include major topics such as performing operations with real numbers; solving linear equations and inequalities; representing linear equations and solving systems of equations; performing operations with polynomials and quadratics; and performing operations with functions and non-linear equations. Other competencies for college algebra are possible. As another example, for a human biology course, competencies may include introduction to human biology; skeletal and muscular systems; nervous system and sensory system; respiratory, circulatory and immune systems; urinary, endocrine, digestive, and reproductive systems; and genetics and biotechnology. Other competencies for college biology are possible.

The example challenges engine 304 includes challenges for each competency of a course. Challenges are open ended questions in which a student needs to formulate an answer. Requiring students to formulate an answer encourages students to think about a question and understand subject matter associated with the question. If the student doesn't know how to answer the question, the student may access one or more tutorials associated with each challenge, as explained later herein.

The student is given a predetermined number of attempts to answer a question correctly. Typically, for non-mathematical courses, the student is given three attempts to answer a question correctly; however, this number may vary for different courses and challenges. For example, for mathematical courses, a student is commonly given 10 attempts. If a student answers incorrectly after the attempt limit is reached for a question, the answer to the question is presented to the student. Presenting the answer to the student permits the student to understand why the previous attempts were incorrect and facilitates better learning of the subject matter of the challenge.

The number of questions for each challenge may vary for each challenge. Typically, there are 8-10 questions per challenge. In order to pass a challenge, and advance to the next challenge, the student must correctly answer a predetermined percentage of questions for the challenge. Typically, the student must correctly answer at least half of the questions in the challenge. However, as long as the student hasn't exceeded the attempt limit for questions within a challenge, the student may return to the challenge to try to answer the question correctly. A student must achieve a score of at least 70 percent for all questions (including all challenges and the milestone) for a competency. So the student is motivated to try to increase his/her score. There is no penalty for incorrect answers when using multiple attempts to answer a question.

The milestones engine 306 includes a milestone for each competency. The student must pass each challenge for the competency, typically answering at least half of the questions in each challenge correctly, before the student is permitted to advance to a milestone. Each milestone typically consists of 25 questions, the majority of which are multiple choice questions. Each milestone exam is timed and the student has 1-3 hours to complete each milestone exam. To pass the milestone, the student must answer at least half of the 25 questions in the milestone exam correctly. However, as stated, in order to pass the competency, the student must achieve a score of at least 70 percent for a combination of the challenges and the milestone in the competency. Typically, the milestone is weighed twice as much as the challenges for the purposes of calculating the student's final score.

The example tutorials engine 308 includes video tutorials associated with each competency. As discussed earlier herein, a philosophy used for the online university is to challenge students to answer questions to problems without formal classes or lectures. However, when a student does not know how to answer a question or when the student needs to learn or relearn concepts, the student may view one or more of the video tutorials. As a further aid to student learning, tutorials on the same topic are typically available from multiple instructors. If a student still as questions on the material of a topic after viewing one tutorial, the student may view a different tutorial by a different instructor on the same topic. Because different instructors may teach the same subject matter in a different way, the student may find it easier to learn the material of a topic from a plurality of instructors and video tutorials.

The example ID verification milestone engine 310 includes a final exam type of test for each course. The student must pass the ID verification milestone in order to successfully complete the course. In addition to verifying student knowledge for the course, the ID verification milestone verifies the identity of the student. The ID verification milestone is proctored online to ensure student authentication and academic integrity. Typically, the ID verification milestone is taken on a laptop or desktop computer that is equipped with a webcam and microphone. The student's identity may be verified by showing a government issued ID to the proctor via the webcam. The student may also need to answer a series of questions to verify the student's identity.

FIG. 4 shows an example home page user interface 400 for a student that has signed-in to the example online university website. The example home page user interface 400 shows two example courses—a college algebra course 402 and a human biology course 404. Other example courses may be displayed by clicking backward arrow 406 and forward arrow 408. When the student clicks on an example display area 410 of a course, a user interface screen is displayed for the course. If the course is one that the user has already signed up for, the user interface screen displayed for the course shows a current status for the student for the course. If the course is one that the student has not signed up for, the user interface screen displayed for the course permits the student to sign up for the course.

FIG. 5 shows an example user interface 500 for the college algebra course 402. The user interface 500 is displayed when the display area 410 is selected on the example college algebra course 402. The user interface 500 includes a progress area 502. The progress area shows a schedule for the course. Typically, a student is given 60 days to complete a course. The progress area shows a projected completion date of Apr. 4, 2013 for the course. In addition, the course provides suggested dates as goals for when the student should try to complete each competency in the course so that the student can make the projected completion date of Apr. 4, 2013. For example, the college algebra course 402 includes five competencies, as will be discussed further herein. The suggested dates for having completed the challenges and milestone for these competencies are Feb. 17, 2013, Mar. 1, 2013, Mar. 12, 2013, Mar. 24, 2013 and Apr. 5, 2013, respectively.

The progress area 502 also includes a graphic 504 which shows the student's current score for the course. As discussed earlier, a student must achieve a score of 70 percent or higher in order to pass the course. The score is derived across all challenges and the milestone in the competency. When calculating the score, each correct answer within a challenge is given a weight of one and each correct answer within a milestone is given a weight of two. The graphic 504 shows that after completing two challenges, the student has a score of 85 percent.

The user interface 500 shows that the example college algebra course 402 includes five example competencies—506, 508, 510, 512 and 514. As discussed, a competency corresponds to a major topic in the course. For the college algebra course 402, competency 506 comprises performing operations with real numbers, competency 508 comprises solving linear equations and inequalities, competency 510 comprises representing linear equations and solving systems of equations, competency 512 comprises performing operations with polynomials and quadratics and competency 514 comprises performing operations with functions and non-linear equations. Each competency is shown with a plus sign or minus sign to the left of the name of the competency. Clicking on a plus sign shows the challenges and milestone within the competency and changes the plus sign to a minus sign.

As shown in FIG. 5, competency 506 includes three challenges—516, 518 and 520—and one milestone 522. As shown, the student has completed challenges 516 and 518, answering 9 out of 10 questions correctly on challenge 516 and answering 8 out of 10 questions correctly on challenge 520. Because the student has answered 17 questions correctly out of a total of 20 possible questions, the student has a current score of 85 percent, as shown on graphic 504. As discussed earlier, the student has a predetermined number of attempts to answer a challenge question correctly. The student may improve his/her score on a challenge if the student has not exceeded the predetermined number of attempts. Display area 517 indicates that the student may improve his/her score on challenge 516 and display area 519 indicates that the student may improve his/her score on challenge 518. Display area 521 indicates that challenge 520 is the next challenge to take. Display area 523 indicates, via an example lock icon, that milestone 1 is not available for taking. The student must pass all three challenges (answering at least half of questions for each challenge correctly) before being able to take milestone 1.

Also, as shown in FIG. 5, competency 506 includes a selection for a practice milestone 524 and a selection for a study guide 526. The practice milestone is a sample milestone exam on which the student may practice before taking the actual milestone. The study guide 526 comprises a plurality of video tutorials corresponding to subject matter within competency 506. As explained in more detail later herein, the video tutorials provide the student with help in understanding the subject matter within competency 506. Each example competency 506, 508, 510, 512, 514 provides links to a practice milestone and a study guide.

The user interface 500 also includes an example display area 528 for initiating a chat with a learning coach and an example display area 530 for viewing a student report page. The online university provides a learning coach for each student. The learning coach helps make sure the student is making progress towards completing each course and also is available for tutorial purposes to answer questions the student may have. Clicking display area 528, initiates an online chat session with the learning coach for the student or with a different learning coach if the learning coach for the student is not available. The student report page provides a detailed report of the student's progress in the course, as explained in detail later herein. Clicking display area 530 brings up a display of the student report page.

FIG. 6 shows a user interface 600 that displays all the challenges and milestones within the college algebra course 402. The user interface 600 shows that each competency comprises three challenges and one milestone. For other courses, there may be more or fewer competencies within a course and more or fewer challenges within a competency.

FIG. 7 shows an example user interface 700 that shows an example challenge question. The user interface 700 is displayed when the example display area 517 for improving a score on a challenge is selected. The user interface 700 displays a question for which the student previously answered incorrectly and for which the number of attempts for answering the question has not been exceeded. For example, the user interface 700 displays an area 702 which indicates that 9 out of 10 questions for challenge 1 have been already answered correctly. Display area 704 shows questions 1-8 and 10 with a checkmark, indicating that these questions have already been answered correctly. Question 9 is shown without a checkmark, and may also be shown in a highlighting color or pattern, indicating that question 9 has not been answered correctly. Display area 706 uses an “x” to indicate that question 9 has been answered incorrectly and also indicates that, for this example, there are 9 attempts remaining to answer the question correctly. Display area 708 shows an answer previously submitted for question 9, in this case an incorrect answer.

To help the student answer question 9 correctly, a hint 710 is provided. If the hint is not sufficient to permit the student to answer the question, the user may access a video tutorial that may help the student further. The video tutorial is identified by a hyperlink 712. For this example, the video tutorial displayed via hyperlink 712 discusses dividing in scientific notation. The student may also access one or more additional video tutorials that discuss subject matter related to question 9. For this example, the additional video tutorials are identified by hyperlinks 714, 716 and 718. Hyperlink 714 displays a video tutorial for converting to scientific notation. Hyperlink 716 displays a video tutorial for quotient of a power property for exponents. Hyperlink 718 displays a video tutorial for converting to negative exponents.

When the student is ready to submit an answer for question 9, the student writes the answer in display area 720 and then clicks the Submit My Answer button 722. The display area 720 indicates the units in which the answer should be in, for example in seconds per configuration, and also provides instructions for how to format the answer. When the answer is submitted, a determination is made as to whether the answer is correct. Typically, the answer is sent to a server computer, for example to web server computer 108, to determine whether the question is correct. In some cases, where there may be some ambiguity in the answer, more than one correct answer may be acceptable. The online university may use a history of the way in which previous students have answered a question to determine whether more than one answer may be correct.

FIG. 8 shows an example user interface 800 for a video tutorial. The example user interface 800 is displayed when hyperlink 714, corresponding to converting in scientific notation, is selected. The user interface 800 shows the name 802 of the video tutorial, a rating 804 for the video tutorial, the author 806 of the video tutorial and an objective 808 for the video tutorial. The rating 804 is typically provided by students who rated the video tutorial after viewing the video tutorial. The objective 808 provides an overview of what the video tutorial is about. The value of the rating 804, the name of the author 806 and the description of the objective 808 may help the student determine whether to view the video tutorial.

To view the video tutorial the user clicks play button 810. After viewing the video tutorial, the student may understand the subject matter of the video tutorial sufficiently to attempt another answer at question 9. However, whenever the student is still not clear about one or more aspects of the subject matter, the user may use a “many ways” aspect of the online university to try and learn the subject matter from other video tutorials. The “many ways” aspect of the online university is based on an idea that instructors may teach the same subject matter differently. A student that may not understand the subject matter from one instructor may be able to learn the subject matter better from another instructor, or from a combination of instructors.

A “many ways” area 812 is displayed at the bottom of the user interface 800. The “many ways” area 812 displays descriptions for one or more video tutorials, in this case for three video tutorials, that cover the same subject matter as the video tutorial activated by play button 810. Display areas 814, 816 and 818 describe the three video tutorials. Each description includes the name of the video tutorial, the author of the video tutorial and a rating for the video tutorial. Viewing the description of each video tutorial, for example the author and the rating, may help the student determine which, if any, video tutorial to view. The user interface 800 also includes an example quiz 820 that the student may use to further test the student's understanding of the subject matter in the video tutorials viewed.

FIG. 9 shows an example user interface 900 for a practice milestone test 902. The user interface 900 is displayed when practice milestone 524 is clicked on user interface 500. The practice milestone test 902 includes a plurality of multiple choice questions that tests subject matter for competency 506—performing operations with real numbers. An answer key to the practice milestone test 902 is typically provided at the end of the practice milestone test 902. Typically, one or more practice milestone tests are linked to each competency, so that the student may practice for the actual milestone exam for the competency.

FIG. 10 shows an example user interface 1000 listing tutorials for performing operations with real numbers. The user interface 1000 is displayed when a display area for study guide 526 is clicked on user interface 500. The tutorials comprise a study guide for competency 506. The tutorials are available for the student when the student feels that he/she may not have sufficient background in the subject matter covered in competency 506 and needs help in understanding the subject matter. Each competency in a course includes a link to tutorials covering the subject matter of the competency. Each of the tutorials is typically a video tutorial.

The tutorials listed on user interface 1000 are organized into 10 units. A different number of units may be used for other competencies. For user interface 1000, unit 1 comprises tutorials for discovering number types, unit 2 comprises tutorials for performing operations with integers, unit 3 comprises tutorials for applying order of operations, etc. Each unit may be expanded to list tutorials associated with the unit. For example, unit 1, discovering number types 1002, includes tutorial 1004 on rational numbers, tutorial 1006 on irrational numbers, tutorial 1008 on imaginary numbers, tutorial 1010 on complex numbers and tutorial 1012 on number system relationships. Each tutorial 1004, 1006, 1008, 1010 and 1012 includes a hyperlink to the tutorial. For example, clicking on the hyperlink for tutorial 1004 brings up a user interface for a video tutorial on rational numbers. The user interface for the video tutorial on rational numbers is similar to user interface 800 for the video tutorial on converting to scientific notation, including a rating, an author, the actual video tutorial and a “many ways” display area by which the student can choose a similar video tutorial on the same subject matter.

FIG. 11 shows an example user interface 1100 for a student report page. The user interface 1100 is displayed when display area 530 for view report page is selected on user interface 500. The student report page shows the student's progress to date across all challenges and milestones. The student report page has columns for challenges 1102 and milestones 1104. As shown, for the college algebra course there are 16 challenges and five milestones. For challenges, the student report page includes columns for correct answers 1106, possible answers 1108, views 1110 and attempts 1112. The possible answers 1108 column corresponds to the number of questions asked for each challenge. The views 1110 column corresponds to the number of video tutorials the student has viewed for each challenge. The attempts 1112 column corresponds to the number of times the student has attempted to answer a question in a challenge. For milestones, the student report page includes columns for correct answers 1114 and for possible answers 1116.

The student report page also shows a current score for the student. The score is calculated across all challenges and milestones in the course. The score is calculated by dividing a number of correct answers by a number of possible answers across all challenges and milestones in the course. An example note 1118 indicates that milestone questions are worth twice as much as challenge questions. Another way of saying this is that the total score from the milestones are weighted twice as much as the total score from the challenges. To calculate a grand total score 1120 for the student, the correct answers from all milestones are added and the sum of the correct answers from all milestones is multiplied by two. The number of correct answers from the milestones multiplied by two and then added to the total correct answers from all of the challenges. The possible answers from all milestones are added and multiplied by two. The possible answers from the milestones multiplied by two are then added to the total possible answers from all the challenges. To calculate the grand total score 1120, the correct answers from the sum of the milestones multiplied by two and the total correct answers from all of the challenges is divided by the sum of the possible answers from the milestones multiplied by two and the total possible answers from all of the milestones. As shown, the current grand total score 1120 for the student is 85 percent. In order to pass a course, after all the challenges and milestones in the course are completed, the grand total score 1120 must be 70 percent or greater.

FIG. 12 shows an example flowchart 1200 for a method for mastery-based online learning. At operation 1202, a user interface for the online course is rendered on client computer 102, on mobile electronic device 104 or on other similar client computers or mobile electronic devices. For the discussion of flowchart 1200, client computer 102 is used. The user interface rendered at operation 1202 identifies online courses that are available to a student of the online university. Example online courses are college algebra, human biology, introduction to sociology, introduction to art history, etc.

At operation 1204, the student makes a selection of an online course. When the student selects the course, the student commits to a timeline whereby the course is to be completed within a specified number of days, typically 60 days.

At operation 1206, challenges and a milestone are rendered for topics of the online course. Each online course is comprised of a plurality of topics. In this disclosure, the topics are also referred to as competencies. Example competencies for the college algebra course include performing operations with real numbers and solving linear equations and inequalities. A plurality of challenges and a milestone are associated with each competency. Each challenge comprises a series of open-ended questions related to the competency. An open-ended question is a question for which the student must formulate an answer. There is one milestone associated with each competency. Each milestone is a series of multiple choice questions related to the competency. Students are permitted multiple attempts to obtain a correct answer for challenge questions. Depending on the subject matter, students are typically permitted between three and ten attempts. If the student gets a wrong answer on a challenge question, the student is encouraged to view one or more video tutorials associated with the challenge question in order to better understand the subject matter associated with the question in order to improve the students score. After the student passes all the challenges associated with a competency, typically by obtaining at least half of the questions for each challenge correct, the student may then take the milestone. The student has only one attempt to pass the milestone.

At operation 1208, the student selects a challenge and questions for the challenge are rendered on client computer 102. For example, referring to FIG. 7, when the student user selects a challenge question, for example by selecting a question at display area 704, the question is displayed. As indicated by display area 720, each challenge question is an open-ended question, requiring the student to formulate an answer and enter the answer in display area 720.

At operation 1210, answers are received for challenges for the topic selected. The student may select challenges in any order and may answer questions for the selected challenge in any order. The answers are sent to a server computer, for example, web server computer 108 to determine whether the answers are correct.

At operation 1212, a determination is made whether the student has passed a challenge. In order to pass a challenge, the student must correctly answer more than a predetermined percentage of questions correct on the challenge. Typically, the student must correctly answer at least half of the questions on a challenge in order to pass the challenge. However, even if a student passes a challenge, the student may return to the challenge to try to improve his/her score, as long as the student has not exceeded the attempts limit for all of the questions in the challenge. The student may submit answers for any challenge question for which the attempts limit for the question has not been exceeded. There is no penalty for multiple attempts at an answer. For example, if the student has not passed a challenge, and the student wants to retry a question, control returns to operation 1208 where the questions for the challenge are rendered.

At operation 1212, when a determination is made that the student has passed all challenges for a competency, at operation 1214 questions for the milestone for the competency are rendered. The milestone comprises a series of mainly multiple choice questions, typically 25 questions, on the competency. The milestone is a timed exam, typically taking from 1-3 hours. Students may take a sample milestone exam before taking the actual milestone. Typically, the student has only one chance to pass a milestone.

At operation 1216, answers are received to the questions on the milestone. The answers are sent to server computer, for example to web server computer 108, for grading. At operation 1218, a determination is made as to whether the student passed the milestone. Typically, the student must answer at least half of the questions in the milestone correctly in order to pass the milestone. When a determination is made at operation 1218 that the student did not pass the milestone, the student is not permitted to continue. Typically, the student has a consultation with a learning coach to determine the next steps to follow. Depending on the policies of the online university, the student may be permitted to re-take the milestone. Other outcomes are possible.

At operation 1218, when a determination is made that the student passed the milestone, at operation 1220 a determination is made as to whether an overall score for the student is greater that a predetermined percentage, typically 70 percent. The overall score is calculated across all challenges and milestones for the online course. The calculation is typically made by a server computer, for example web server computer 108. When making the calculation, each correct milestone is given a weight of two. In an example calculation for the overall score, the number of correct answers for all challenges is added to two times the number of correct answers for all milestones. This sum of the number of correct answers for all challenges and two times the number of correct answers to all milestones is divided by the sum of the total number of questions for all challenges and two times the number of questions for all milestones.

When a determination is made at operation 1220 that the overall score for the student is less than 70 percent, the student still may try to improve his/her score on challenge questions if the student has not exceeded the attempt limit on the challenge questions. The student may also want to discuss his/her situation with a learning coach before proceeding further.

When a determination is made at operation 1220 that the student's score is greater than 70 percent, at operation 1222, the student takes the ID verification milestone. The ID verification milestone is an exam which is proctored online to ensure student authentication and academic integrity. Typically, there are 25 questions on the ID verification milestone. Each of the 25 questions is obtained from completed milestones for the student. Only questions that the student has answered correctly are used.

At operation 1224, a determination is made as to whether the student passed the ID verification milestone. Passing requirements may vary for different online universities. Typically, a passing score of 70 percent on the ID verification milestone is required.

At operation 1224, when a determination is made that the student has not passed the ID verification milestone, the online course ends. The student may need to consult administrative personnel at the online university to determine what the next steps may be.

At operation 1224, when a determination is made that the student has passed the ID verification milestone, at operation 1226, a designation is made that the student has successfully completed the online course.

FIG. 13 illustrates example physical components of the web server computer 108. As illustrated in the example of FIG. 13, the web server computer 108 includes at least one central processing unit (“CPU”) 1302, a system memory 1308, and a system bus 1322 that couples the system memory 1308 to the CPU 1302. The system memory 1308 includes a random access memory (“RAM”) 1310 and a read-only memory (“ROM”) 1312. A basic input/output system contains the basic routines that help to transfer information between elements within the web server computer 108, such as during startup, is stored in the ROM 1312. The web server computer 108 further includes a mass storage device 1314. The mass storage device 1314 is able to store software instructions and data.

The mass storage device 1314 is connected to the CPU 1302 through a mass storage controller (not shown) connected to the bus 1322. The mass storage device 1314 and its associated computer-readable data storage media provide non-volatile, non-transitory storage for the web server computer 108. Although the description of computer-readable data storage media contained herein refers to a mass storage device, such as a hard disk or solid state disk, it should be appreciated by those skilled in the art that computer-readable data storage media can be any available non-transitory, physical device or article of manufacture from which the central display station can read data and/or instructions.

Computer-readable data storage media include volatile and non-volatile, removable and non-removable media implemented in any method or technology for storage of information such as computer-readable software instructions, data structures, program modules or other data. Example types of computer-readable data storage media include, but are not limited to, RAM, ROM, EPROM, EEPROM, flash memory or other solid state memory technology, CD-ROMs, digital versatile discs (“DVDs”), other optical storage media, magnetic cassettes, magnetic tape, magnetic disk storage or other magnetic storage devices, or any other medium which can be used to store the desired information and which can be accessed by the web server computer 108.

According to various embodiments of the invention, the web server computer 108 may operate in a networked environment using logical connections to remote network devices through the network 1320, such as a local network, the Internet, or another type of network. The web server computer 108 may connect to the network 1320 through a network interface unit 1304 connected to the bus 1322. It should be appreciated that the network interface unit 1304 may also be utilized to connect to other types of networks and remote computing systems. The web server computer 108 also includes an input/output controller 1306 for receiving and processing input from a number of other devices, including a keyboard, a mouse, a touch user interface display screen, or another type of input device. Similarly, the input/output controller 1306 may provide output to a touch user interface display screen, a printer, or other type of output device.

As mentioned briefly above, the mass storage device 1314 and the RAM 1310 of the web server computer 108 can store software instructions and data. The software instructions include an operating system 1318 suitable for controlling the operation of the web server computer 108. The mass storage device 1314 and/or the RAM 1310 also store software instructions, that when executed by the CPU 1302, cause the web server computer 108 to provide the functionality of the web server computer 108 discussed in this document. For example, the mass storage device 1314 and/or the RAM 1310 can store software instructions that, when executed by the CPU 1302, cause the web server computer 108 to communicate web page data to client computer 102 or mobile electronic device 104.

Other example physical components of the web server computer 108 are possible. In general, the web server computer 108 supports a computing platform that provides capabilities for a standardized interface (for example USB), a standardarized wireless communication interface (for example Bluetooth or NFC) and a user interface.

FIG. 14 shows an alternate view of example components 1400 in system 100. The example components 1400 include web browser client 102, 104, application components 1402, user activity database 1404 and content/assessment database 1406. The web browser client 102, 104 are the example client computer 102 and the example mobile electronic device 104. The example application components comprise various application engines on web server computer 108. The example user activity database 1404 and the example content/assessment database 1406 comprise database 110.

The application components 1404 include example engines 1408-1438. The assessment editor and viewer 1408 provides an assessment and view of student progress. The assessment determines a student's progress in courses for which the student has registered. The student's progress may be displayed in one or more views, for example via user interface 1100 and by one or more views accessible to administrators. The online proctor service 1410 provides online coaching services to students, controlling communication between students and online coaches. The user authentication engine 1420 authenticates the identities of students that log on the online university website. The user authorization engine 1414 authorizes access to the online university website.

The tutorial editor and viewer 1416 controls the organization and display of video tutorials for students. The equation editor and 1418 viewer controls the editing and display of equations presented to students in challenges and milestones. The course editor and viewer permits the editing, typically by an administrator, and display to students of courses available to students. The search engine 1422 controls searches performed on the online university website.

The video transcoder 1424 handles the transcoding of video tutorials. The PDF transcoder 1426 handles the transcoding of PDFs used on the online university website. The email delivery engine 1428 controls the delivery of emails from students and administrators on the online university website. The job queue processor 1430 controls internal task processing for the online university website.

The payment processor engine 1432 handles the processing of payments from students. The content management engine 1434 controls course content for the online university website. The learning preference assessment engine 1436 controls ways in which information is presented to students. The site administration module 1408 controls administration for the online university website.

The user activity database 1404 stores information relating to user activity for the online university website. User activity typically refers to student activity. Example information stored in the user activity database 1404 includes assessment outcomes, user posts, user events, user profiles, rating, questions and groups. Other user information is possible for the user activity database 1404.

The content/assessment database 1406 stores information relating to content and assessment for the online university website. The content and assessment information includes tutorials, tutorial media such as video, PDF and slideshow, academic concept and standard taxonomy, learning preferences, assessment items and versioning, courses and playlists.

Although various embodiments are described herein, those of ordinary skill in the art will understand that many modifications may be made thereto within the scope of the present disclosure. Accordingly, it is not intended that the scope of the disclosure in any way be limited by the examples provided.

What is claimed is:

1. A method implemented on an electronic computing device for learning in on an online university, the method comprising:
on the electronic computing device, rending a first user interface for the online university, the user interface permitting the selection of one or more online courses;
receiving a selection of an online course;
after the selection of the online course is received, rendering a second user interface showing a plurality of challenges and a milestone associated with a first topic of a plurality of topics included in the online course, each challenge corresponding to a plurality of first questions relating to the first topic, each first question being an open-ended question, each milestone corresponding to a plurality of second questions relating to the first topic, each second question being a multiple choice question;
receiving answers to the first questions for each of the challenges;
when a number of correct answers to the first questions of each challenge is greater than a first predetermined percentage, rendering a third user interface on the electronic computing device, the third user interface showing the plurality of second questions relating to the first topic, the third user interface prevented from being rendered until the correct answers to the first questions for each of the challenges is greater than the first predetermined percentage;
receiving answers to the second questions; and
when a number of correct answers of the plurality second questions is greater than a second predetermined percentage, designating that the milestone for the first topic has been passed.

2. The method of claim 1, further comprising displaying a score for a student taking the online course, the score being calculated from correct answers to all first questions and all second questions for the plurality of topics of the online course, each correct answer to a first question being given a weighting of one and each correct answer to a second question being given a weighting of two.

3. The method of claim 2, wherein the score is displayed on a speedometer-like graphic that is rendered on the electronic computing device.

4. The method of claim 2, wherein a student is permitted to submit a different answer to an incorrect question if an attempt limit for the question is less than a predetermined value.

5. The method of claim 1, further comprising:
receiving answers to first questions and second questions for all additional topics of the plurality of topics for the online course;
obtaining a score for the student based on answers received for all the first and second questions;
when a determination is made that the score for the student is greater than a third predetermined percentage, rendering a fourth user interface on the electronic computing device, the fourth user interface showing a plurality of third questions relating to the online course, each of the third questions being obtained from correctly answered questions from the plurality of second questions;
receiving answers to the third questions; and
when a determination is made that a number of correct answers to the third questions is greater than a fourth predetermined percentage, designating that the student has successfully completed the online course.

6. The method of claim 1 further comprising rendering a user interface for a plurality of video tutorials directed to the first topic, each of the video tutorials being presented by a different instructor.

7. The method of claim 1, further comprising displaying a user interface that reports student progress, the user interface that reports student progress showing all first questions answered correctly and all attempts at each first question.

8. The method of claim 1, further comprising displaying a user interface for initiating a communication with an online learning coach.

9. A web server computer including a processor and memory, the memory containing computer executable instructions, which when executed by the processor cause the processor to generate web page data and to communicate the web page data across a data communication network to end user computing devices, the web server being communicatively connected to a database, wherein the web page data generated by the processor defines at least a first web page for online learning, the first web page comprising a plurality of topics associated with an online course, each topic including a plurality of challenges and one milestone, each challenge comprising a first series of questions related to the online course, the milestone comprising a second series of questions related to the online course, wherein the milestone is not available to the student until a test score on each of challenges is above a first predetermined percentage.

10. The web server computer of claim 9, wherein the web page data further comprises a study guide for each of the plurality of topics, the study guide providing access to a plurality of video tutorials associated with each of the plurality of topics.

11. The web server computer of claim 9, wherein each challenge provides access to a plurality of video tutorials associated with a topic corresponding to the challenge.

12. The web server computer of claim 11, wherein two or more of the video tutorials associated with a specific topic are provided by different instructors.

13. The web server computer of claim 9, wherein the first web page further includes a status display indicating the student's progress, the status display including a speedometer-type graphic displaying a progress score for the student.

14. The web server computer of claim 9, wherein the first web page includes an area for initiating an online chat with a learning coach.

15. The web server computer of claim 9, wherein the web page data further defines a second web page for displaying student progress for the online course, the student progress including a display of a number of questions the student has answered correctly for each of the plurality of challenges and milestones in the online course.

16. The web server computer of claim 9, wherein the student must correctly answer at least half of the questions on each challenge and each milestone in order to successfully complete the online course.

17. The web server computer of claim 9, wherein the student must achieve a score of 70 percent across all challenges and milestones in order to successfully complete the online course.

18. The web server computer of claim 9, wherein the first web page permits a student to complete a challenge without watching any video tutorials first.

19. The web server computer of claim 9, wherein each question in a challenge requires a written answer by a student.

20. An online learning system implemented at least in part on a server computer, the system comprising:
a processor;
a memory;
a student engine, the student engine processing identification information for a plurality of students that are registered in the online learning system;
a courses engine, the courses engine providing access to one or more online courses that are available to the plurality of students, the courses engine comprising:
a competencies engine, the competencies engine organizing each of the one or more online courses into topics of study;
a challenges engine, the challenges engine providing one or more series of first questions to test a student's understanding of each of the topics of study, each of the one or more series of first questions being designated as a challenge, each of the one or more series of first questions being open ended, requiring a student to formulate an answer; and
a milestones engine, the milestones engine providing a plurality of second questions to test the student's understanding of each of the topics of study, each of the second questions being multiple choice questions, the second questions being accessible to the student only after all challenges for a unit have been passed, the passing of a challenge comprising correctly answering at least half of the first questions for the challenge; and
a reports engine that provides data relating to student performance.
